(19) United States
(12) Patent Application Publication
(10) Pub. No.: US 2024/0186063 A1
(43) Pub. Date: Jun. 6, 2024

(54) WINDING APPARATUS AND ANTENNA COIL MANUFACTURED THEREBY

(71) Applicant: AMOTECH CO., LTD., Incheon (KR)

(72) Inventors: Minjun KIM, Incheon (KR); Euijin JUNG, Incheon (KR); Eulyoung JUNG, Incheon (KR); Jinsam YOO, Incheon (KR); Gyujin OH, Incheon (KR); Jooseung MAENG, Incheon (KR)

(73) Assignee: AMOTECH CO., LTD., Incheon (KR)

(21) Appl. No.: 18/285,845

(22) PCT Filed: Apr. 4, 2022
(86) PCT No.: PCT/KR2022/004776

§ 371 Date: Oct. 5, 2023

(30) Foreign Application Priority Data
Apr. 6, 2021 (KR) 10-2021-0044390

(51) Int. Cl. H01F 41/096; H01F 41/061; H01F 41/088; H01Q 7/00

(52) U.S. Cl. CPC H01F 41/096; H01F 41/061; H01F 41/088; H01Q 7/00

(57) ABSTRACT

Disclosed are: a winding apparatus having a cut surface formed on a side surface of a rotation jig so as to prevent metal wire from being unnecessarily rotated at the time of winding the metal wire; and an antenna coil having a loop shape including at least one straight line section. The disclosed antenna coil includes: a loop wound multiple times around a winding axis on a same plane; a first end part disposed in an inner circumferential area of the loop; and a second end part disposed in an outer circumferential area of the loop, wherein the loop includes one or more straight line sections.

### TECHNICAL FIELD

The present disclosure relates to a winding apparatus for manufacturing an antenna coil used as a radiator for short-range communication, wireless power transmission and reception, or the like, and an antenna coil manufactured thereby.

### BACKGROUND ART

Antenna coils are used as radiators in short-distance communication antennas, wireless power transmission antennas, wireless power reception antennas, or the like. An antenna coil is mainly manufactured in a loop shape. Although the production of the antenna coil was mainly performed manually, there has been a problem in that an additional process such as planarization should be performed due to irregular winding or protrusion of a surface.

Therefore, recently, the antenna coil has been manufactured by automatically winding coils through a winding apparatus.

### SUMMARY OF INVENTION

### Technical Problem

The present disclosure has been proposed in consideration of circumstances and is directed to providing a winding apparatus, which has a cut surface formed on a side surface of a rotation jig and prevents the unnecessary rotation of a metal wire at the time of winding a metal wire, and a loop-shaped antenna coil having at least one straight line section.

### Solution to Problem

In order to achieve the object, a winding apparatus according to an embodiment of the present disclosure includes a jig driven rotatably and configured to wind a metal wire, wherein the jig includes a rotation jig formed in a cylindrical shape having a first bottom surface, a second bottom surface, and a side surface formed with a cut surface and configured to rotate about a winding axis orthogonal to the first bottom surface and the second bottom surface to wind the metal wire, and a support plate disposed in contact with the first bottom surface of the rotation jig and configured to guide the metal wire wound by the rotation jig to be wound on the same plane.

The metal wire may be wound around the side surface of the rotation jig multiple times to form a loop-shaped flat coil having one or more straight line sections.

The cut surface may be orthogonal to the first bottom surface and the second bottom surface, and the rotation jig may have a straight line section formed by the cut surface. In this case, the straight line section may be a section which is parallel to the first bottom surface and the second bottom surface of the rotation jig and parallel to a virtual straight line passing a winding axis.

The rotation jig may be formed with a plurality of cut surfaces to have a plurality of straight line sections. In this case, the plurality of straight line sections may be sections which are parallel to the first bottom surface and the second bottom surface of the rotation jig and parallel to one of virtual straight lines passing the winding axis, and the plurality of straight line sections may be parallel to different virtual straight lines.

In order to achieve the object, an antenna coil manufactured by the winding apparatus according to the embodiment of the present disclosure includes a loop wound around a winding axis multiple times on the same plane, a first end portion disposed in an inner circumferential surface of the loop, and a second end portion disposed in an outer circumferential surface of the loop, wherein the loop has one or more straight line sections. In this case, the straight line section may be a section which is parallel to the same plane and in which a virtual straight line passing a center point of the loop and the loop are disposed parallel to each other. Here, the loop may have a plurality of straight line sections which are parallel to the same plane and in which one of virtual straight lines passing a center point of the loop and the loop are disposed parallel to each other.

### Advantageous Effects of Invention

According to the present disclosure, the winding apparatus may have the straight line section formed on the rotation jig and uniformly wind the metal wire, thereby reducing a defect rate and improving workability.

In addition, the winding apparatus may have the straight line section formed on the rotation jig to prevent the unnecessary rotation of the metal wire, thereby preventing the nonuniform winding of the metal wire or a degradation in flatness in the winding process and thus decreasing the worker's movement and decreasing the unnecessary mass-production consumption time.

In addition, the winding apparatus may manufacture the antenna coil in which the metal wire is uniformly wound and thus flatness is maintained.

### BRIEF DESCRIPTION OF DRAWINGS

FIGS. 1 and 2 are views for describing a winding apparatus according to an embodiment of the present disclosure.

FIG. 3 is a view for describing a jig in FIG. 1.

FIG. 4 is a view for describing an example of the rotation jig in FIG. 3

FIG. 5 is a view for describing a modified example of the rotation jig in FIG. 3.

FIG. 6 is a view for describing an example of an antenna coil manufactured by the winding apparatus according to the embodiment of the present disclosure.

FIGS. 7 and 8 are views for describing a modified example of the antenna coil manufactured by the winding apparatus according to the embodiment of the present

### DISCLOSURE

### Description of Embodiments

Hereinafter, the most preferred embodiment of the present disclosure will be described with reference to the accompanying drawings in order to describe the present disclosure in detail to the extent that those skilled in the art can easily carry out the technical spirit of the present disclosure. First, in adding reference numerals to components in each drawing, it should be noted that the same components have the same reference numerals as much as possible even when they are shown in different drawings. In addition, in describing embodiments of the present disclosure, when it is determined that the detailed description of related known configurations or functions may obscure the gist of the present disclosure, a detailed description thereof will be omitted.

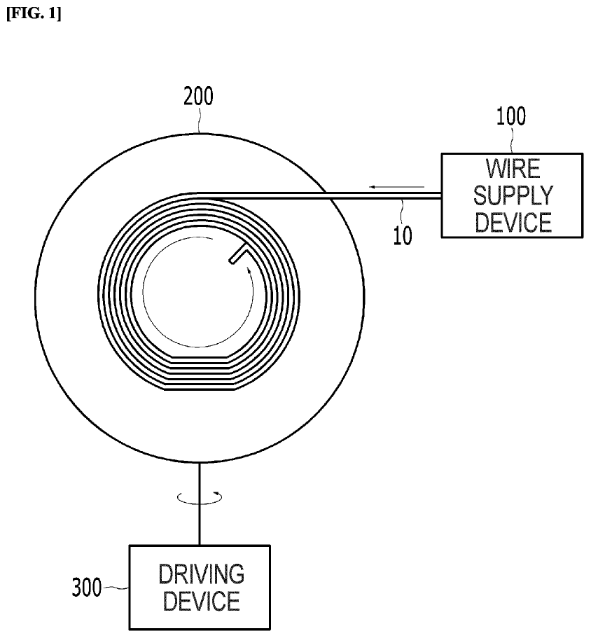

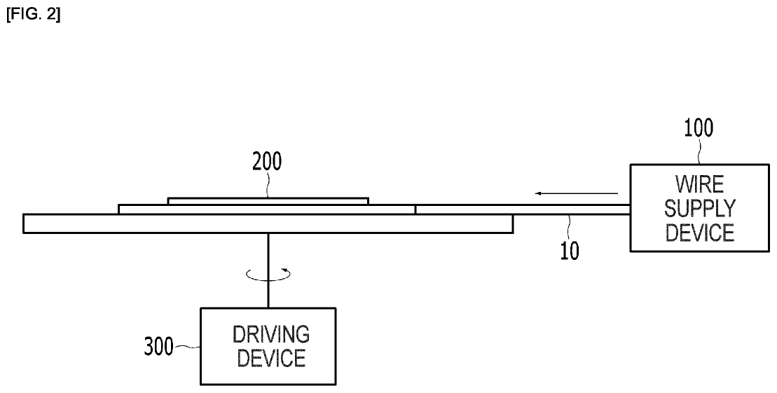

Referring to FIGS. 1 and 2, a winding apparatus according to an embodiment of the present disclosure includes a wire supply device 100, a jig 200, and a driving device 300.

The wire supply device 100 supplies a metal wire 10 to the jig 200. The wire supply device 100 supplies the metal wire 10 in a state of being wound around a bobbin to the jig 200. In this case, the wire supply device 100 may supply the metal wire 10 to the jig 200 through a separate driving source. The wire supply device 100 may supply the metal wire 10 to the jig 200 by tension generated by the rotation of the jig 200.

The jig 200 is rotated by the driving device 300 and winds the metal wire 10 supplied from the wire supply device 100 to manufacture a loop-shaped antenna coil. Here, for example, the antenna coil is a loop-shaped flat coil wound around a virtual winding axis orthogonal to a plane multiple times.

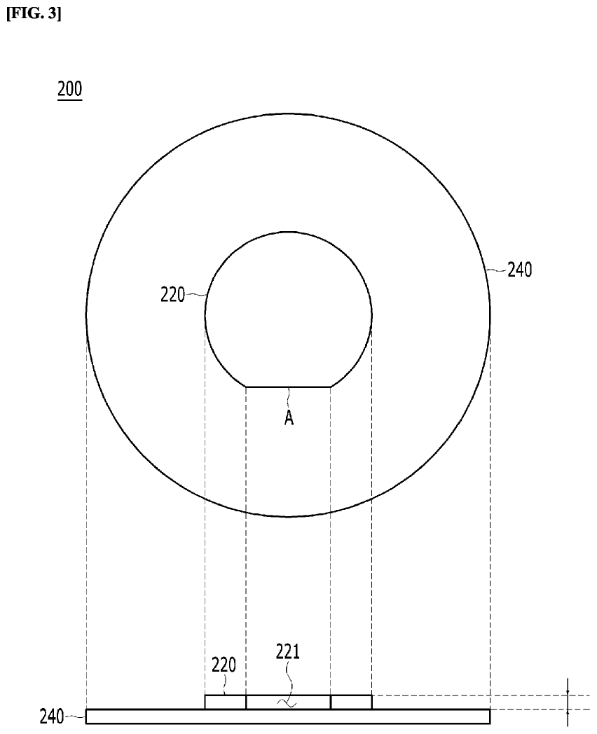

Referring to FIG. 3, the jig 200 includes a rotation jig 220 and a support plate 240. Here, in FIG. 3 and the following description, it is illustrated and described that the jig 200 includes only the support plate 240 disposed on a first bottom surface of the rotation jig 220 for easy description of the embodiment of the present disclosure, but the present disclosure is not limited thereto, and the jig 200 may further include another support plate (not illustrated) disposed on a second bottom surface of the rotation jig 220 and facing the support plate 240 in order to maintain the smoothness of the antenna coil in a process of winding the metal wire 10.

The rotation jig 220 is rotated by the driving device 300 and formed in a cylindrical shape having the first bottom surface and the second bottom surface facing each other, and a side surface. The rotation jig 220 is rotated by the driving device 300 and rotates about a virtual rotational axis orthogonal to the first bottom surface and the second bottom surface of the rotation jig 220. In this case, the metal wire 10 supplied from the wire supply device 100 forms the loop-shaped antenna (i.e., the flat coil) wound around the rotation jig 220 multiple times using the rotation jig 220 as a central axis as the rotation jig 220 rotates.

When the rotation jig 220 is configured to have a lower height than a thickness of the metal wire 10, the metal wire 10 may be unwound or smoothness may be decreased in the process of winding the metal wire 10. Therefore, the rotation jig 220 is configured to have a height that is larger than or equal to the thickness of the metal wire 10.

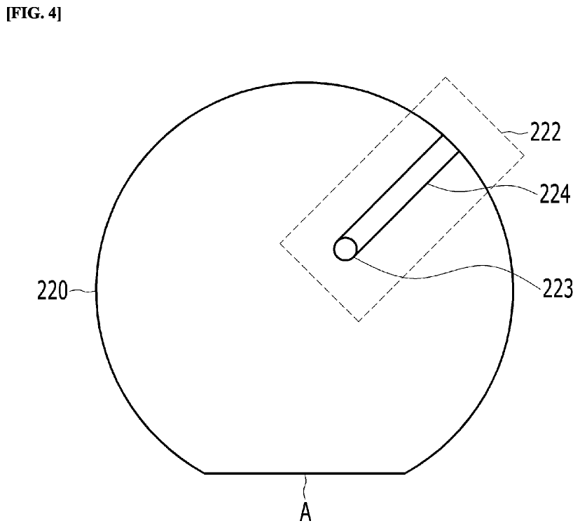

Referring to FIG. 4, the rotation jig 220 includes a fixing part 222 for fixedly supporting an end portion of the metal wire 10, and the fixing part 222 includes a fitting hole 223 and a guide groove 224.

The fitting hole 223 is disposed in an inner circumference of the rotation jig 220 when viewed from the top of the rotation jig 220. The fitting hole 223 is formed by removing a portion of the second bottom surface of the rotation jig 220 and fixedly supports the end portion of the metal wire 10 supplied from the wire supply device 100. In this case, the fitting hole 223 may be formed in various shapes such as circular and rectangular shapes.

The guide groove 224 guides a path through which the metal wire 10 of which the end portion is fixedly supported in the fitting hole 223 is discharged to the outside of the rotation jig 220. To this end, the guide groove 224 is formed from the fitting hole 223 to an outer circumference of the rotation jig 220. The guide groove 224 is formed to communicate from the fitting hole 223 to the outer circumference of the rotation jig 220.

When the rotation jig 220 is formed in a cylindrical shape (i.e., a circular shape when viewed from the top of the rotation jig 220), unnecessary rotation may occur in the metal wire 10 in the process of winding the metal wire 10, thereby degrading winding uniformity or degrading the flatness of the antenna coil.

Therefore, in the embodiment of the present disclosure, a cut surface 221 is formed on a side surface of the rotation jig 220. The cut surface 221 is formed by cutting a portion of the rotation jig 220. In other words, as the portion of the rotation jig 220 is cut, the cut surface 221 is formed on the side surface of the rotation jig 220.

When viewed from the top of the rotation jig 220, the cut surface 221 has a straight line section A formed in the portion of the circular rotation jig 220. Here, the straight line section A may be defined as a section in which a virtual straight line passing a center point of the rotation jig 220 and the cut surface 221 are parallel.

For example, the cut surface 221 has a quadrangular shape formed by cutting a portion of the rotation jig 220 in a direction orthogonal to the first bottom surface and the second bottom surface of the rotation jig 220, and the straight line section A is formed in the rotation jig 220. Therefore, the metal wire 10 is wound in a loop shape that is wound around the rotation jig 220 multiple times and has the straight line section A.

As described above, the winding apparatus may have the straight line section A formed in the rotation jig 220, thereby minimizing a change in design in the antenna coil and preventing the unnecessary rotation of the metal wire 10.

In addition, the winding apparatus may have the straight line section A formed in the rotation jig 220, thereby improving workability while uniformly winding the metal wire 10.

In addition, the winding apparatus may have the straight line section A formed in the rotation jig 220 to prevent the unnecessary rotation of the metal wire 10, thereby preventing the nonuniform winding of the metal wire 10 or a degradation of flatness in the winding process and thus decreasing the worker's movement and decreasing the unnecessary mass-production consumption time.

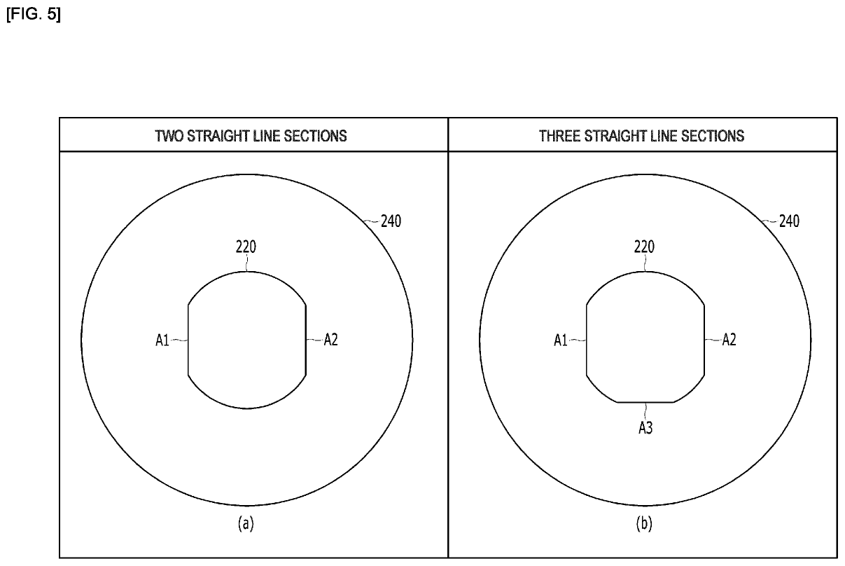

Referring to FIG. 5, the rotation jig 220 may be formed with a plurality of cut surfaces 221 to form a plurality of straight line sections A1 and A2 or A1 to A3. Therefore, the metal wire 10 may be wound in a loop shape that is wound around the rotation jig 220 multiple times and has the plurality of straight line sections A1 and A2 or A1 to A3.

The support plate 240 is disposed on the first bottom surface of the rotation jig 220. The support plate 240 is formed of a plate-shaped base and disposed on the first bottom surface of the rotation jig 220. Here, the support plate 240 may be coupled to the rotation jig 220 and configured to rotate together with the rotation jig 220.

The support plate 240 supports the metal wire 10 wound around the rotation jig 220 by the rotation of the rotation jig 220 and guides the metal wire 10 to be wound on the same plane. In other words, the support plate 240 supports (guides) the metal wire 10 wound around the rotation jig 220 so that the smoothness of the antenna coil is maintained in the winding process.

The driving device 300 rotates the jig 200 by applying a rotating force to the jig 200. For example, the driving device 300 is formed of a motor and rotates the jig 200.

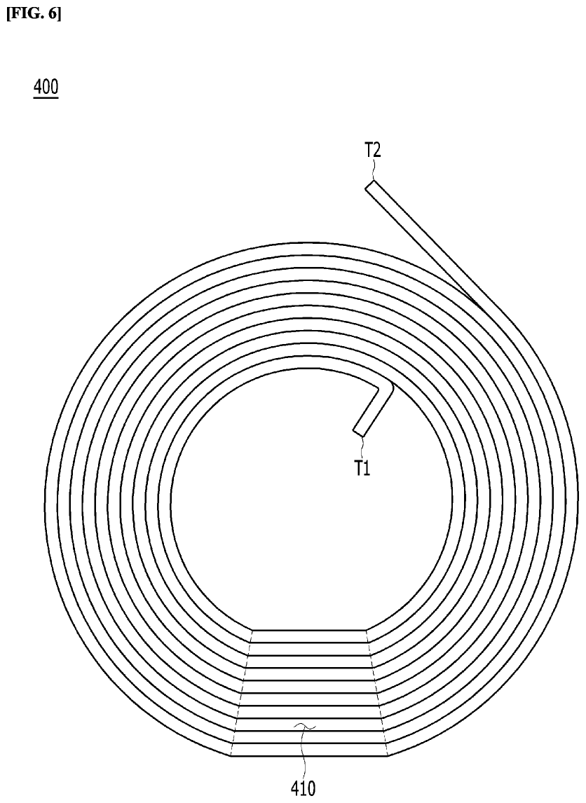

Referring to FIG. 6, the antenna coil 400 manufactured by the winding apparatus according to the embodiment of the present disclosure is formed in a loop shape having a first end portion T1 and a second end portion T2. In this case, the first end portion T1 of the antenna coil 400 is disposed in an inner circumferential region of the loop, and the second end portion T2 of the antenna coil 400 is disposed in an outer circumferential region of the loop.

The antenna coil 400 is formed in a circular loop shape and has a straight line section 410. In this case, the antenna coil 400 has the straight line section 410 disposed parallel to a virtual straight line passing the center point of the loop shape formed by the antenna coil 400.

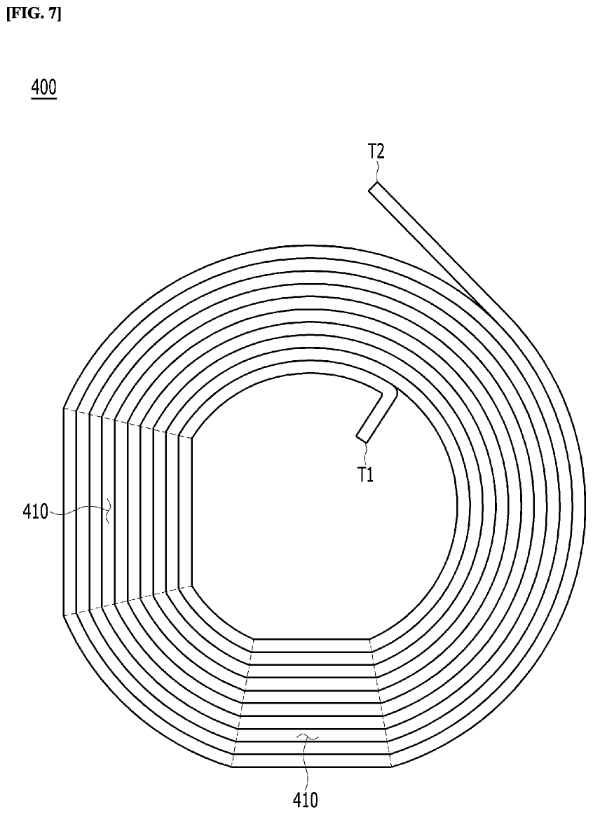

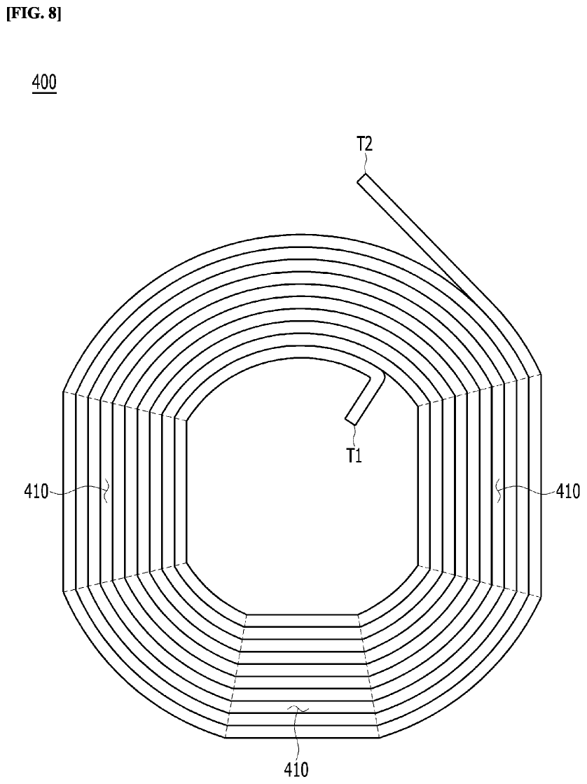

Referring to FIGS. 7 and 8, the antenna coil 400 may be formed in a circular loop shape and may have a plurality of straight line sections 410. In this case, the antenna coil 400 has the plurality of straight line sections 410 disposed parallel to one of virtual straight lines passing the center point of the loop shape formed by the antenna coil 400.

Although the preferred embodiments of the present disclosure have been described above, modifications can be made in various forms, and those skilled in the art can carry out various changes and modifications without departing from the claims of the present disclosure.

1. A winding apparatus comprising a jig driven rotatably and configured to be winded a metal wire,
wherein the jig includes:
a rotation jig formed in a cylindrical shape having a first bottom surface, a second bottom surface, and a side surface formed with a cut surface and configured to rotate about a winding axis orthogonal to the first bottom surface and the second bottom surface to wind the metal wire; and
a support plate disposed in contact with the first bottom surface of the rotation jig and configured to guide the metal wire wound by the rotation jig to be wound on the same plane.

2. The winding apparatus of claim 1, wherein the metal wire is wound around the side surface of the rotation jig multiple times to form a loop-shaped flat coil having one or more straight line sections.

3. The method according to claim 1, wherein the cut surface is orthogonal to the first bottom surface and the second bottom surface.

4. The winding apparatus of claim 1, wherein the rotation jig has a straight line section formed by the cut surface.

5. The winding apparatus of claim 4, wherein the straight line section is a section which is parallel to the first bottom surface and the second bottom surface of the rotation jig and parallel to a virtual straight line passing a winding axis.

6. The winding apparatus of claim 1, wherein the rotation jig is formed with a plurality of cut surfaces to have a plurality of straight line sections.

7. The winding apparatus of claim 6, wherein the plurality of straight line sections are sections which are parallel to the first bottom surface and the second bottom surface of the rotation jig and parallel to one of virtual straight lines passing the winding axis, and
the plurality of straight line sections are parallel to different virtual straight lines.

8. An antenna coil comprising:
a loop wound around a winding axis multiple times on the same plane;
a first end portion disposed in an inner circumferential surface of the loop; and
a second end portion disposed in an outer circumferential surface of the loop,
wherein the loop has one or more straight line sections.

9. The winding apparatus of claim 8, wherein the straight line section is a section which is parallel to the same plane and in which a virtual straight line passing a center point of the loop and the loop are disposed parallel to each other.

10. The winding apparatus of claim 8, wherein the loop has a plurality of straight line sections which are parallel to the same plane and in which one of virtual straight lines passing a center point of the loop and the loop are disposed parallel to each other.
